(19) United States
(12) Patent Application Publication
(10) Pub. No.: US 2016/0224594 A1
(43) Pub. Date: Aug. 4, 2016

(54) Schema Definition Tool

(71) Applicant: Simba Technologies Inc., Vancouver (CA)

(72) Inventors: Kai Yee Chow, Vancouver (CA); Gerald Allen Furseth, Vancouver (CA); James Duong, Vancouver (CA)

(21) Appl. No.: 14/613,053

(22) Filed: Feb. 3, 2015

(51) Int. Cl. G06F 17/30

(52) U.S. Cl. CPC G06F 17/30292; G06F 17/30339; G06F 17/30324; G06F 17/30424

(57) ABSTRACT

Methods, systems, computer-readable media, and apparatuses for providing schema definition generation and management to enable a relational query tool to access data in a non-relational database. The schema definition tool may sample a non-relational database to produce a sample set of a table of the non-relational database and may generate multiple linked virtual tables to represent arrays in the sample set as scalar values. The schema definition tool may then automatically generate a table definition for each real and virtual table of the non-relational database to produce a schema definition representing the structure of the non-relational database. A relational query tool may now use the schema definition to format relational queries or commands to access data residing in the non-relational database.

### FIELD

Aspects of the disclosure relate to computer hardware and software. In particular, one or more aspects of the disclosure generally relate to computer hardware and software for providing a schema definition tool for automatically enabling NoSQL databases to function as SQL databases using virtual tables.

### BACKGROUND

Due to the computationally intensive nature of SQL databases, its inability to easily scale, and the cheap abundance of data storage, many big data and website companies have shifted to using NoSQL databases rather than SQL databases. NoSQL databases offer many advantages over SQL databases. For example, NoSQL databases are easier to horizontally scale, are much less complex, and provide a greater level of flexibility (e.g., it's easier to divide up the work for multi-tasking over numerous processors). However, while some NoSQL databases support some SQL-like query languages, many NoSQL databases do not support SQL queries. In fact, many NoSQL databases have their own unique query structure that database operators have to learn in order to use that particular NoSQL database. However, many database operators have been trained in and have decades of experience with SQL databases. For example, most database operators have intimate knowledge of SQL tools that use a specific SQL query structure to retrieve data from SQL databases. Thus, a vast amount of resources, both in terms of time and money, is wasted as a result of database operators having to learn a new query language in order to use a particular NoSQL database.

Further, SQL tools are incompatible and/or otherwise cannot access data residing in NoSQL databases. For example, a particular field value of column in a NoSQL database may be an object such as an embedded array. Since SQL tools only recognize scalar values, SQL tools cannot recognize or utilize the embedded array. As a result of this incompatibility, not only do the database operators have to learn a new query language, but they must also purchase and learn query tools specific to each NoSQL database. Additionally, the operator must now use two separate tools to access data residing in a SQL databases and data residing in a NoSQL database, respectively.

One current “solution” involves physical manipulation of data residing in a NoSQL database to a SQL database by extracting the data from the NoSQL database into files and then imported the data into a SQL database. This “solution” disadvantageously requires the use of two databases storing duplicative data and eviscerates the benefits that NoSQL databases provide over SQL databases. For example, as noted above, one benefit of a NoSQL database over a SQL database is ease of horizontal scaling. For this “solution” to work, every time the NoSQL database is horizontally increased in scale, so too would its SQL database counterpart, which is very difficult to accomplish in a SQL database. Further, even under this “solution,” a single SQL tool would still not be able to access data residing in NoSQL databases.

Accordingly, there are deficiencies in the way applications and tools access and manipulate data in SQL databases and NoSQL databases.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

A schema definition tool for automatically enabling non-relational databases (e.g., NoSQL databases) to function as relational databases (e.g., SQL databases). The schema definition tool samples a non-relational database to produce a sample set of one or more tables (e.g., collections) of the non-relational database and generates multiple linked virtual tables to represent objects (e.g., embedded array) in the sample set as scalar values. The schema definition tool may then automatically generate a table definition for each real and virtual table of the non-relational database and produce a schema definition representing the structure of the non-relational database. An operator may then use the schema definition tool to refine the schema definition including editing the table definitions of the virtual tables. The schema definition tool may then store the schema definition in a synthetic schema cache for access by a relational query tool (e.g., a SQL query tool). As a result, a relational query tool may now use the schema definition of the non-relational database to manipulate and/or retrieve data residing in the non-relational database. Because the virtual tables are linked to real data in the non-relational database, the relational query tool may also retrieve scalar values that are contained within embedded arrays of the non-relational database.

In some embodiments, a relational driver may include the schema definition tool, manage a synthetic schema cache, and include a relational engine to process queries conforming to the synthetic schema by utilizing a non-relational database's native application programming interface (API).

In some embodiments, a system may include a non-relational database and a server communicatively coupled to the non-relational database. The system may also include a computing device communicatively coupled to the server and includes a processor and a computer readable medium storing instructions that, when executed by the processor, cause the computing to device to perform a number of tasks. The computing device may transmit to the server instructions to sample and filter one or more tables residing in the non-relational database. The computing device may receive from the server a sample set that meets each constraint provided in the instructions. The computing device may determine that a cell in a table includes an array and may determine the number of element in the array. The computing device may generate a virtual table that duplicates the table but replaces a column of the virtual table that includes the array with a column representing the number of elements in the array. The computing device may generate a schema definition for the non-relational database that includes a table definition of the virtual table.

In some embodiments, an apparatus may include a processor and a computer readable medium storing instructions that, when executed by the processor, cause the apparatus to perform a number of tasks. The apparatus may send, to a server, instructions to sample a non-relational database communicatively coupled to the server. The apparatus may determine that a cell in a table of the sample dataset includes an array and, in response, may generate a virtual table that represents the array. The apparatus may determine that a column of the virtual table has multiple different data types and, in response, may assign a data type for the column to represent the multiple different data types. The apparatus may generate a schema definition of the non-relational database that includes the assigned data type for the column.

In some embodiments, a method may be performed by a computing device. The computing device may sample a non-relational database to obtain a table. The computing device may determine that a cell in the table includes an array and, in response, may generate a first virtual table and a second virtual table. The first virtual table may represent the table and the second virtual table may represent the array. The computing device may generate a schema definition that includes a first table definition for the first virtual table and a second table definition for the second virtual table.

These features, along with many others, are discussed in greater detail below.

### BRIEF DESCRIPTION OF THE DRAWINGS

The present disclosure is illustrated by way of example and not limited in the accompanying drawings in which like reference numerals indicate similar elements and in which:

FIG. 1 depicts an illustrative network architecture and data processing device that may be used to implement one or more illustrative aspects described herein;

FIG. 2 depicts an illustrative system that may be used to implement one or more illustrative aspects discussed herein;

FIGS. 3-5 depict an illustrative method to automatically provide a schema definition of a non-relational database that may be used to implement one or more illustrative aspects discussed herein;

FIGS. 6 and 7 depict illustrative real tables of a non-relational database that may be used in accordance with one or more illustrative aspects discussed herein;

FIGS. 8-11 depict various illustrative virtual tables generated to represent objects contained within the table of FIG. 7 in accordance with one or more illustrative aspects discussed herein;

FIG. 12 depicts an illustrative virtual table in accordance with one or more illustrative aspects discussed herein; and

FIG. 13 depicts an illustrative user interface for viewing and editing a schema definition for the virtual table of FIG. 12 in accordance with one or more illustrative aspects discussed herein.

### DETAILED DESCRIPTION

In the following description of the various embodiments, reference is made to the accompanying drawings, which form a part hereof, and in which is shown by way of illustration various embodiments in which a schema definition management solution may be practiced. It is to be understood that other embodiments may be utilized and structural and functional modifications may be made without departing from the scope of aspects discussed herein. The schema definition management system is capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

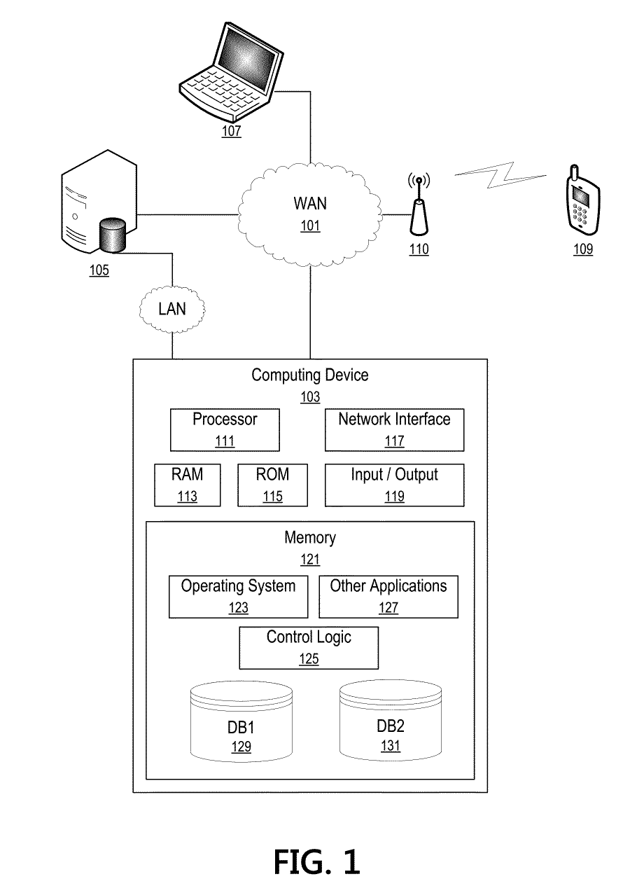

FIG. 1 illustrates one example of a network architecture and data processing device that may be used to implement one or more illustrative aspects described herein. Various network nodes 103, 105, 107, and 109 may be interconnected via a wide area network (WAN) 101, such as the Internet. Other networks may also or alternatively be used, including private intranets, corporate networks, LANs, wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109 and other devices (not shown) may be connected to one or more of the networks via twisted pair wires, coaxial cable, fiber optics, radio waves or other communication media. One or more devices (e.g., device 109) may be connected using a cellular connection with base station 110 that is communicatively coupled to WAN 101 to communicate with the other devices.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects described herein. Data server 103 may be connected to web server 105 through which users interact with and obtain data as requested. Alternatively, data server 103 may act as a web server itself and be directly connected to the Internet. Data server 103 may be connected to web server 105 through the network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device and may have the same components as data server 103. Data server 103, e.g., may include a processor 111 controlling overall operation of the data server 103. Data server 103 may further include RAM 113, ROM 115, network interface 117, input/output interfaces 119 (e.g., keyboard, mouse, display, printer, etc.), and memory 121. I/O 119 may include a variety of interface units and drives for reading, writing, displaying, and/or printing data or files. Memory 121 may further store operating system software 123 for controlling overall operation of the data processing device 103, control logic 125 for instructing data server 103 to perform aspects as described herein, and other application software 127 providing secondary, support, and/or other functionality which may or may not be used in conjunction with aspects discussed herein. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (QoS), etc.

One or more aspects of the schema definition management system may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein.

The schema definition management system may be implemented using the network architecture described in FIG. 1. For example, the schema definition system may be implemented via one or more of the data server 103, the web server 105, and/or the client computers 107, 109.

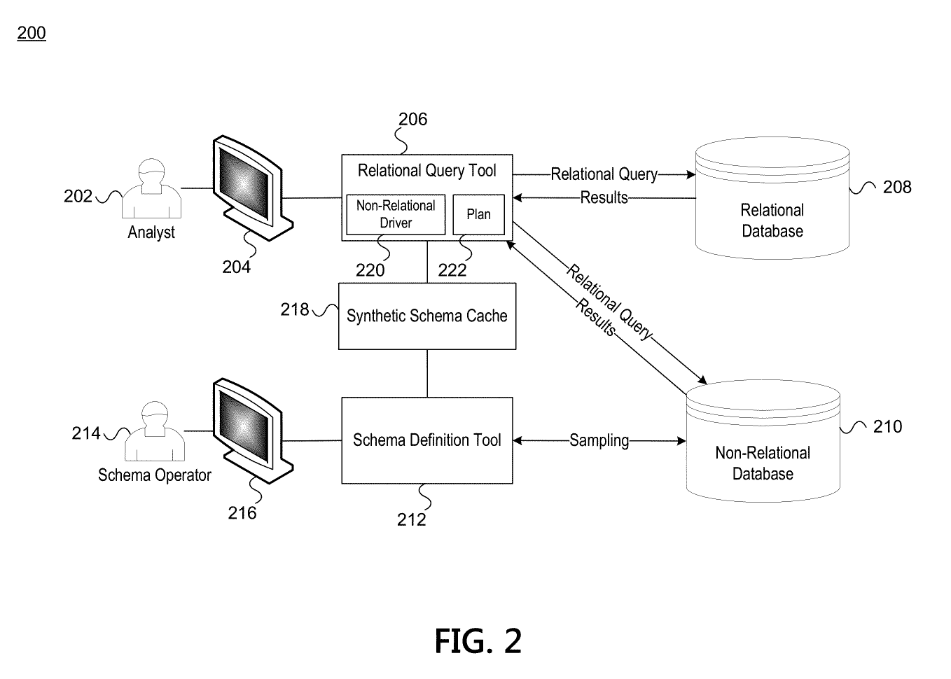

FIG. 2 depicts an illustrative system that may be used to implement one or more illustrative aspects discussed herein. For example, a system 200 may include a relational query device 204 (e.g., devices 103, 105, 107, 109) that may include a relational query tool 206 to transmit relational queries/commands input by analyst 202, to a server (e.g., devices 103, 105, 107, 109) including relational database 208, to manipulate relational data residing in relational database 208 and/or retrieve a relational dataset from relational database 208. The relational database 208 may be a special-purpose programming language (SQL) database including multiple relationally-linked tables. Each relational table may be in the form of rows (records) and columns (fields) and may store scalar data values. The relational query tool 206 may retrieve from the server including relational database 208 a metadata definition file for use with accessing relational data. The metadata file may include table definitions, fields, relationships, indexes, types, indexes, and other elements of relational database 208.

System 200 may include schema definition device 216 (e.g., devices 103, 105, 107, 109) including schema definition tool 212 to automatically enable non-relational databases 210 to function as relational databases. While schema definition tool 212 is shown as being separate from relational query tool 206, it should be understood that the relational query tool 206 may include the schema definition tool 212 as one of its drivers. Non-relational database 210 may be a not only SQL (NoSQL) database that includes one or more collections (e.g., tables) of fields/attributes (e.g., columns) and documents (e.g., rows) to store both scalar data values and objects (e.g., embedded arrays).

Because non-relational database 210 is schema-less, schema definition tool 212 may automatically produce a schema definition for non-relational database 210. For example, schema definition tool 212 samples non-relational database 210 to produce a sample set of collections (e.g., tables). If any of the tables contain objects or arrays, schema definition tool 212 generates multiple linked virtual tables to represent the arrays as scalars since relational query tool 206 may only access and interpret scalar values. Schema definition tool 212 may then generate a table definition for each of the real and generated virtual tables to create a schema definition representing the structure of non-relational database 210. A schema operator 214 may then use schema definition tool 212 to refine the schema definition including editing the table definitions of the real and virtual tables. Schema definition tool 212 may store the schema definition in synthetic schema cache 218 for access by relational query tool 206.

As a result, relational query tool 206 may now use the schema definition of non-relational database 210 to format relational queries for non-relational database 210. For example, relational query tool 206 may include a non-relational driver 220 to access data items of non-relational database. Relational query tool 206 may manipulate and/or retrieve data items of non-relational database 210 by drawing upon the schema definition stored in synthetic schema cache 218 to manifest and declare the type of data that is available within non-relational database 210. As a result, a single tool (relational query tool 206) may access data items in a relational database and data items in a non-relational database. Further, because the virtual tables are linked to real data items in non-relational database 210, relational query tool 206 may also retrieve scalar values that are contained within embedded arrays of non-relational database 210. For example, the schema definition presents an array containing a mix of String and Double as a table of SQL VarChar values.

In some instances, the non-relational database's API may be insufficient to fulfill all of the relational semantics of a relational query. For example, a query may include a filter condition (e.g., retrieve values greater than 100) but the non-relational database's API has no facility to filter its data. In such instances, non-relational driver 220 may over-fetch the data items from non-relational database 210 and may process the particular filter condition itself using an execution plan 222 that stays within the non-relational database's limited API.

In some embodiments, a non-relational driver 220 may dynamically create the schema for each query instead of using the schema in the synthetic schema cache 218 created originally by the schema definition tool 212. For example, schema definition tool 212 may translate a relational query into a non-relational database's own query language (e.g., Splunk's SPL or Couchbase's N1QL). Based on the result set data and statistics for the result set for the translated query, the driver infers the data type for each column of the result set. Non-relational driver 220 may determine that when the number of total unique values in the column is the same as the number of numeric values within the column that the data type ought to be a double. If so, the column is reported as having a numeric data type such as a double. If not, the column is reported as have a data type of string.

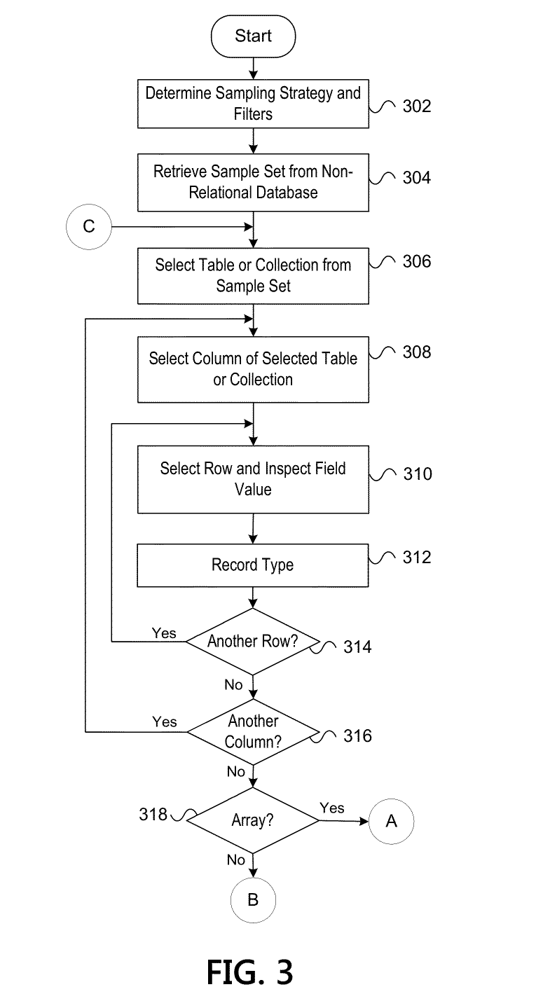

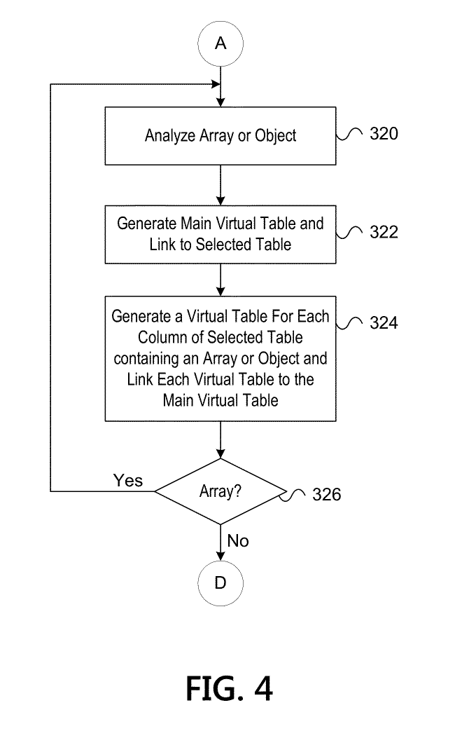

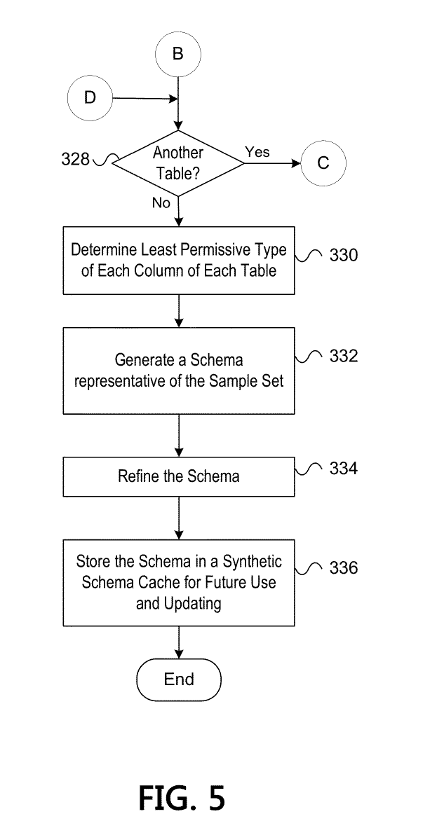

FIGS. 3-5 depict an illustrative method to automatically provide a schema definition of a non-relational database that may be used to implement one or more illustrative aspects discussed herein. In one or more embodiments, the method of FIGS. 3-5 and/or one or more steps thereof may be performed by a computing device (e.g., data server 103). In other embodiments, the method illustrated in FIGS. 3-5 and/or one or more steps thereof may be embodied in computer-executable instructions that are stored in a computer-readable medium, such as a non-transitory computer-readable memory. In some instances, one or more of the steps of FIGS. 3-5 may be performed in a different order. In some instances, one or more of the steps of FIGS. 3-5 may be omitted and/or otherwise not performed. In alternative embodiments, the schema definition tool 212 may generate the schema definition prior to receiving and/or writing a relational query from relational query tool 206.

As seen in FIG. 3, the method may begin at step 302 in which a computing device (also referred to herein as schema definition tool 212) may determine a sampling strategy and filters. For example, in step 302, schema operator 214 may select the sampling strategy and filters. The sampling strategies may determine a subset of the data within the non-relational database 210 to use as the sample set. Sampling strategies include a selected first number of entries (e.g., rows or documents), a selected last number of entries, and a selected number of random entries distributed throughout the table. Filters may include date ranges, values above or below a selected number, number of entries to sample, or the like. For example, schema operator 214 may only want to retrieve relatively recent data entries so she may specify a date range as a constraint for the returned sample set. For example, schema operator 214 may also specify the number of entries (rows) to sample.

In step 304, schema definition tool 212 may retrieve a sample set from non-relational database 210. For example, schema definition tool 212 may send an instruction (e.g., a query, command, etc.) instructing the server for non-relational database 210 to sample its tables and may identify the selected sampling strategy and filters. In response, the server for non-relational database 210 may perform the sampling of its tables in accordance with the sampling strategy and filters. For example, the server may retrieve the first 400 rows of the tables that are also associated with a selected date range filter (e.g., last two weeks, from July 7 to July 21, etc.) and may send the subset of those tables to the schema definition tool 212 for use as the sample set.

In step 306, schema definition tool 212 may select a table or collection from the sample set. In step 308, schema definition tool 212 may select the first column of the selected table and, in step 310, may select the first row of the selected column and inspect the field value at that location. In step 312, schema definition tool 212 may determine the value's type either by inspecting the value or by consulting a metadata file retrieved from non-relational database 210 and may record the value's data type in a recordation log stored at the schema definition tool 212.

In step 314, schema definition tool 212 may determine whether the table includes another row and, if so, may iteratively repeat steps 310, 312, and 314 for the next row. Once each of the rows for the selected column have been inspected, schema definition tool 212 may, in step 316, determine whether the table includes another column and, if so may repeat steps 308, 310, 312, 314 and 316 for the next column of the selected table until schema definition tool 212 has inspected and/or otherwise analyzed each row and column of the selected table.

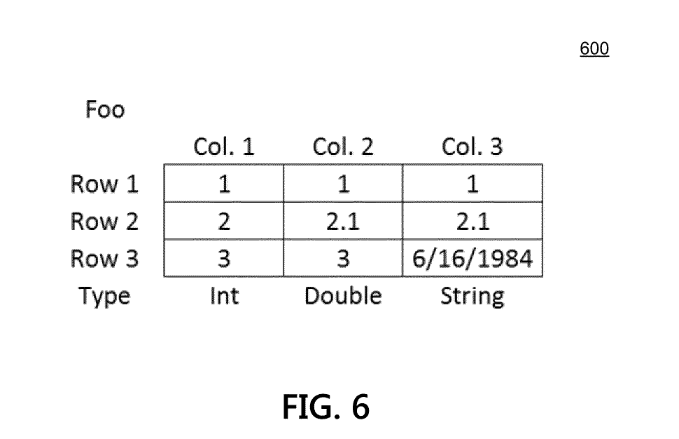

For example, a first table 600 of the sample set may be the table titled “Foo” shown in FIG. 6. As shown in Foo, schema definition tool 212 may select the first column (step 308), the first row (step 310), and record the data type for the value “1” in the recordation log as NumberInt (step 312). Schema definition tool 212 may then select the second row of the first column (steps 314 and 310) and may record the data type for the value “2” in the recordation log as NumberInt (step 312). Schema definition tool 212 may then select the third row of the first column (steps 314 and 310) and may record the data type for the value “3” in the recordation log as NumberInt (step 312). Schema definition tool 212 may select the second column (steps 316 and 308) and iteratively record data types for values in each row (steps 310, 312, 314). Schema definition tool 212 may select the third column (steps 316 and 308) and iteratively record types for values in each row (steps 310, 312, 314).

The recordation log may include the title of the table, an identifier of the row and column location (row:column, column:row, or any other table location identifiers), and the type of the value. In the Foo example, the recordation log may identify the table name “Foo” and may use a row:column identification scheme. The recordation log may indicate that Foo has at a NumberInt type at locations 1:1, 2:1, 3:1, 1:2, 3:2, and 1:3, has NumberDouble type at locations 2:2 and 2:3, and has Date type at location 3:3.

Once each of the rows and columns for the selected table have been inspected and their types recorded, schema definition tool 212 may, in step 318, determine whether any of the values had the Array data type (e.g., the value of the field was an array) or whether any of the values had an Object data type (e.g., the value of the field was an object). If so, schema definition tool may perform steps 320-326 until each array and object is accounted for in one or more generated virtual tables discussed in further detail below. If schema definition tool 212 did not discover any arrays or objects, then schema definition tool 212 may, in step 328, determine whether there is another table in the sample set and, if so, may repeat steps 306-328 until schema definition table 212 has analyzed each table of the sample set and generated virtual tables accounting for each discovered object and array.

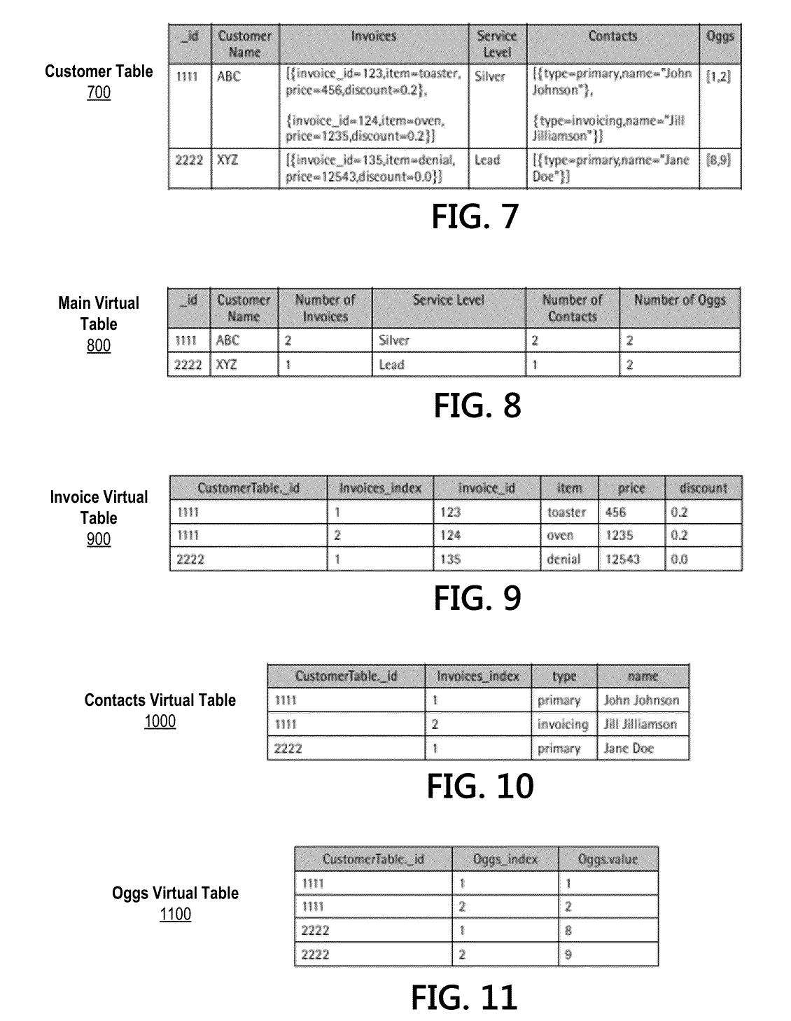

Following the Foo example, schema definition tool 212 may, in step 318, determine that the table 600 titled “Foo” might not have any data item values that have an array data type or an object data type. Schema definition tool 212 may perform this determination by consulting the recordation log. Schema definition tool 212 may, in step 328, determine that there is another table (e.g., table 700 titled “Customer Table” shown in FIG. 7) and, in response, may perform steps 306-328 for table 700 in a similar manner as the steps were applied to table 600.

However, unlike Foo table 600, customer table 700 includes multiple arrays. Thus, when schema definition tool 212 performs step 318, schema definition tool 212 may determine that customer table 700 includes multiple arrays by consulting the recordation log and may then perform steps 320-326 to generate multiple virtual tables to represent each array and object as a scalar value. As noted above, relational query tools (e.g., relational query tool 206) might not natively support accessing non-scalar values such as arrays and objects. By representing arrays and objects as virtual tables of scalar values, relation query tool 206 may be able to access those values from non-relational database 210 enabling the relational query tool 206 to work with arrays and objects. By generating virtual tables rather than real tables, relational query tool 206 may interact with the data but leave the storage of the data in its denormalized form in non-relational database 210.

As shown in FIG. 7, customer table 700 has two columns that have an array of objects in each cell (e.g., Invoices and Contacts columns) and one column that has an array of Scalar types (e.g., the Oggs column). As a result, the recordation log may indicate that the first and second rows of the third column titled “Invoices,” the first and second rows of the fifth column titled “Contacts,” and the first and second rows of the sixth column titled “Oggs” each include values having the data type Array.

In step 320, schema definition tool 212 may analyze the arrays or objects in each cell of the selected (real or virtual) table (e.g., customer table 700) to determine the number of data items included in each array. For example, the cell in the first row of the “Invoices” column has the value [{invoice_id=123, item=toaster, price=456, discount=0.2}, {invoice_id=124, item=oven, price=1235, discount=0.2}], which is an array of two elements (e.g., two objects), namely the first element is {invoice_id=123, item=toaster, price=456, discount=0.2} and the second element is {invoice_id=124, item=oven, price=1235, discount=0.2}. The cell in the second row of the “Invoices” columns has the value [{invoice_id=135, item=denial, price=12543, discount=0.0}], which is an array of one element (e.g., one object). Similarly, as shown in FIG. 7, the array in the cell of the first row of column “Contacts” has two elements and the array in the cell of the second row of column “Contacts” has one element. Additionally, the array in the cell of the first row and the array in the cell of the second row of column “Oggs” each have two elements (e.g., two scalar values).

In step 322, schema definition tool 212 may generate a main virtual table that is linked to the selected (real or virtual) table. For example, schema definition tool 212 may generate main virtual table 800 that includes all of the data of the selected real table except that each column including arrays or objects is replaced with a column identifying the number of elements of an array in each row of the column. For example, schema definition tool 212 may generate main virtual table 800 as shown in FIG. 8. Main virtual table 800 includes all of the data of customer table 700 except that the “Invoices,” “Contacts,” and “Oggs” columns have been replaced with a “Number of Invoices,” “Number of Contacts,” and “Number of Oggs” columns, respectively. Additionally, each cell that contained an array has been replaced with a value representing the number elements in the array. For example, the value [{invoice_id=123, item=toaster, price=456, discount=0.2}, {invoice_id=124, item=oven, price=1235, discount=0.2}] from the “Invoice” column has been replaced by the value “2” in main virtual table 800 to represent the number of elements (e.g., two objects) in the array. For example, the value [1,2] from the “Oggs” column has been replaced by the value “2” in main virtual table 800 to represent the number of elements (e.g., two scalars) in the array.

Note further that the main virtual table 800 is only a different presentation of the data this is also accessible from the non-virtual table 700. As a result, when tools (e.g., relational query tool 206) write or manipulate data in non-relational database 210 using a virtual table, data in the corresponding real table is updated. Additionally, the data within each of these virtual tables can be selected, inserted and updated as if they were normal tables.

In step 324, schema definition tool 212 may generate a virtual table for each column of the selected (real or virtual) table that includes an array or object. (Thus, a virtual table may generate another virtual table if a column is composed of an array of an array.) The virtual tables may represent the arrays or objects of the selected (real or virtual) table. Each of the generated virtual tables may include a reference back to an original primary key column corresponding to the row of the original array. Further, the virtual tables may include a row for each element of the arrays. For example, if a column of the selected table has two arrays, one array with two elements and another array with one element, then schema definition tool 212 may generate a virtual table with three rows, one row for each of the elements. Each row may include a column to indicate the position (e.g., index) of the element in the original array. For example, if the row corresponds to the first element of an array, then the indexed position of the array is “1.” If the row corresponds to the second element of an array, then the indexed position of the array is “2.” Additionally, schema definition tool 212 may expand the data in each element of the arrays by generating a column in the virtual table for each sub-element of the array's elements. If a sub-element already has had a corresponding column generated to represent it in the virtual table, then schema definition tool 212 might not generate another column for the sub-element and instead may place the sub-element in the already generated column.

For example, schema definition tool 212 may generate invoice virtual table 900 to represent the embedded arrays of objects in the Invoice column of customer table 700. Invoice virtual table 900 may include a reference back to the original primary key column of customer table 700. For example, row ids “1111” and “2222” used to identify rows of customer table 700 are also used to identify rows in invoice virtual table 900. Further, invoice virtual table 900 may include a row for each element of each array of customer table 700 and an indication of the position of the element in the corresponding array. For example, element {invoice_id=123, item=toaster, price=456, discount=0.2} was the first element in its array and, thus, its corresponding row in the invoices_index column of invoice virtual table 900 may be the value “1.” Similarly, element {invoice_id=124, item=oven, price=1235, discount=0.2} was the second element in its array and, thus, its corresponding row in the invoices_index column of invoice virtual table 900 may be the value “2.” Additionally, schema definition tool 212 may generate a column for each sub-element of an element of the array. For example, the first element of the array included four sub-elements: sub-element invoice_id=123, sub-element item=toaster, sub-element price=456, and sub-element discount=0.2. As a result, schema definition tool 212 may generate 4 columns (one for each sub-element). If a sub-element already has had a corresponding column generated to represent it in the virtual table, then schema definition tool 212 might not generate another column for the sub-element and instead may place the sub-element in the already generated column. For example, the second element of the array also includes four sub-elements that represent the same type of information as the four sub-elements of the first element, respectively. For instance, the first sub-element of the second element is invoice_id=135, which represents the same type of information (e.g., invoice identifiers) as the first sub-element of the first element, which is invoice_id=123. Thus, schema definition tool 212 might not generate a separate column for the first sub-element of the second element and instead may place the element in the column generated for the first-element of the first element.

Since the Contacts and Oggs columns of customer table 700 also included arrays, schema definition tool 212 may generate virtual tables representing the arrays in these columns in the same manner as discussed above for invoice virtual table 900. As a result, schema definition tool 212 may generate contacts virtual table 1000 to represent the arrays in the contacts column of customer table 700 and may generate Oggs virtual table 1100 to represent the arrays in the Oggs column of customer table 700.

In step 326, schema definition tool 212 may determine whether any of the values in the virtual tables are arrays or objects (e.g., not all of the values are scalar). If so (e.g., there are further embedded arrays or objects in one or more of the virtual tables 800-1100), the schema definition tool 212 may repeat steps 320-326 to generate multiple virtual tables to represent each array and object as a scalar value. In one example, invoice virtual table 900 may include an array (not shown). In step 320, schema definition tool 212 may analyze the arrays in invoice virtual table 900 in the same manner as discussed above. In step 322, schema definition tool 212 may generate a main virtual table based on invoice virtual table 900 in the same manner as the main virtual table 800 was generated based on customer table 700 discussed above. Schema definition tool 212 may also link the generated main virtual table to invoice virtual table 900 in the same manner as discussed above. In step 324, schema definition tool 212 may generate one or more other virtual tables for each column of the invoice virtual table 900 that contains an array and may link each virtual table with the generated main virtual table in the same manner as discussed above. Steps 320-326 may continue to be repeated until all virtual tables only include scalar values and/or otherwise might not include arrays or objects.

Once each of the virtual tables include only scalars (e.g., no arrays or objects), then the process may continue to step 328 to determine whether there is another table in the sample dataset that has not been analyzed. If so, the process returns to step 306. If not, the process continues to step 330. In the example dataset, there were only tables' foo and customer.

In some embodiments, as the schema definition tool 212 builds the virtual tables, it may also record data types of values of the virtual table and store the data type information and the table location information in the recordation log.

In step 330, schema definition tool 212 may determine a least permissive type for each column of each table (real and virtual). Schema definition tool 212 may use the recordation log to determine the least permissive data type for a particular column of a real or virtual table. If each of the values in a selected column have the same type (e.g., they are all values having the data type NumberInt), then that data type is the least constrained data type for that column. If the values in a selected column have different types (e.g., one value has the data type NumberInt and another value has the data type Date), then schema definition tool 212 may determine a data type to which the schema definition tool 212 may convert one or more of the data types of the selected column such that each of the values have the same data type. Schema definition tool 212 may then determine whether the least permissive non-relational data type has an equivalent relational data type in relational database structures. Data types that have no direct mapping from non-relational data types to relational data types may be represented as (e.g., converted to) the varchar relational data type. However, the non-relational data type may be retained for use during insertion and update operations.

For example, in the Foo table 600, each of values of the first column has the same data type of integer (e.g., NumberInt or Int) and, thus, the integer data type is the least permissive type for the first column as shown in FIG. 6. However, the values of the second column have different data types. For example, the data type of the values in the first and third rows are integers but the data type of the value in the second row is a double (e.g., NumberDouble). Because a double data type may accurately represent an integer data type but an integer data type might not accurately represent a double data type, schema definition tool 212 may convert the integer data types to double data types. The third column of Foo table 600 may include a first value in the first row that has a integer data type, a second value in the second row that has a double data type, and a third value in a third row that has a date data type. However, because the integer and double data types might not be converted to the date data type and because the date data type might not be converted to the integer or double data type, schema definition tool 212 may convert each of the data types to a string data type. Additional specific techniques are available for specific types of NoSQL databases.

In step 332, schema definition tool 212 may generate a schema definition for non-relational database 210 using the sample set. For example, schema definition tool 212 may generate a table definition for each real and virtual table. The table definition of a particular table may include multiple table properties and values for the properties. For instance, the table definition may include a source table name (e.g., the name of the table as it appears in non-relational database 210). In some instances, when the relational query tool 206 might not be able to handle characters in or a format of the source table name, the table definition may include a relational table name, which is the name of the table as it will be handled by relational query tool 206 and presented to an application. The relational table name may be mapped to the source table name. The table definition may include a source catalog name (e.g., the name of non-relational database 210). In some instances, the relational query tool 206 might not be able to handle characters in or a format of the source catalog name. In such instances, the table definition may include a relational catalog name (e.g., a name for non-relational database as it will appear to the relational query tool 206). The table definition may specify the number of rows and the number of columns in the table.

The table definition may include a virtual type for the table, such as, for example, the type “any match” for a virtual table that allows writing relational queries that match any values in an array. Another virtual type may include “not virtual” if the table is a real table in non-relational database 210. Another virtual type may include “main” if the table is a main virtual table. Another virtual type may include “array of objects” for a virtual table representing an array of objects. Another virtual type may include “array of objects with child arrays” for a virtual table representing an array of objects that includes child arrays. Another virtual type may include “array of scalars” for a virtual table representing an array of simple data types.

The table definition may include write permissions for the table. Each table that has the virtual type “any match” may have the “read only” permission (e.g., the table is read only). For each of the other tables, the write permissions for the table may be either “read write” (e.g., the table is writeable) or “read only” (e.g., the table is read only).

The schema definition may also include column properties and values for the column properties. Column properties may include the source column name (e.g., the name of the column in non-relational database 210). Column properties may include a relational column name when the source column name includes characters or has a format that the relational query tool 206 might not be able to handle. Column properties may include a relational type assigned to the column using a corresponding least permissive data type discussed above. Column properties may include a source type for the data type of the column in non-relational database 210, which may be used in data selection. Column properties may also include “hide column” properties that may specify whether the column's metadata will be reported to the application, which determines whether the relational query tool 206 may select the column's data.

Column properties may also include behavior properties of the contents of the column. Behavior properties may include whether the content is scalar (e.g., a column including a single data type). Behavior properties may include whether the content is a container (e.g., a column containing an array of data). Behavior properties may include whether the content is a scalar in a container (e.g., a column in a virtual table with a single data type that originated from an array). Behavior properties may include the content's position in the container (e.g., a column in a virtual table that denotes the position of the data within the originating array). Behavior properties may include “any match” behaviors, which may indicate whether column is a searchable column that is used to build query filters between arrays that would otherwise be in separate virtual tables.

Column properties may include a key type for tables. For real tables, the key type may be “not key” to indicate that a column does not reference any type of foreign key. For virtual tables, the key type may either “foreign” or “unique foreign.” The foreign key type may indicate that a column referencing a foreign key may have at least one duplicate key in the table. The unique foreign key type may indicate that a column referencing a foreign key might not have a duplicate key in the table (e.g., it's unique).

Column properties may include relational type hint for columns with string data. Because numerous different data types may be converted to a string data type as discussed above in the Foo example, relational type hints may be generated to indicate the type of data that a column with string data should be treated as or formatted as for insertions or updates to the column. One relational type hint may be “none” when the data type is clear. Another relational type hint may be “array count” to treat the string as an array count. Another relational type hint may be “OID” to treat the string as an object identifier. Another relational type hint may be “JSON” to indicate to format the string in JavaScript object notation (JSON). Another relational type hint may be “BSON” to indicate to format the string in binary JSON.

Column properties may include source nesting level to indicate the level of the column within an object or array. Column properties may also include alternative source types list of possible other non-relational data types that may be used in building query filters.

In step 334, schema operator 214 may refine the schema definition. For example, the schema definition tool 212 may cause the schema definition to be displayed in a user interface of a computing device to permit schema operator 214 to edit the schema definition. Schema definition tool 212 permits schema operator 214 to edit table properties (e.g., relational table name, relational catalog name, permissions, etc.). Schema definition tool 212 permits schema operator 214 to edit column properties (e.g., relational column name, relational type, source type, hide column, etc.). In some embodiments, schema definition tool 212 may cause for display one or more properties but might not permit schema operator 214 to edit the one or more properties (e.g., a read only portion of the schema definition). For example, schema definition tool 212 may display read only properties such as source table name, source catalog name, virtual type, source column name, column behavior, column key type, relational type hint, etc.

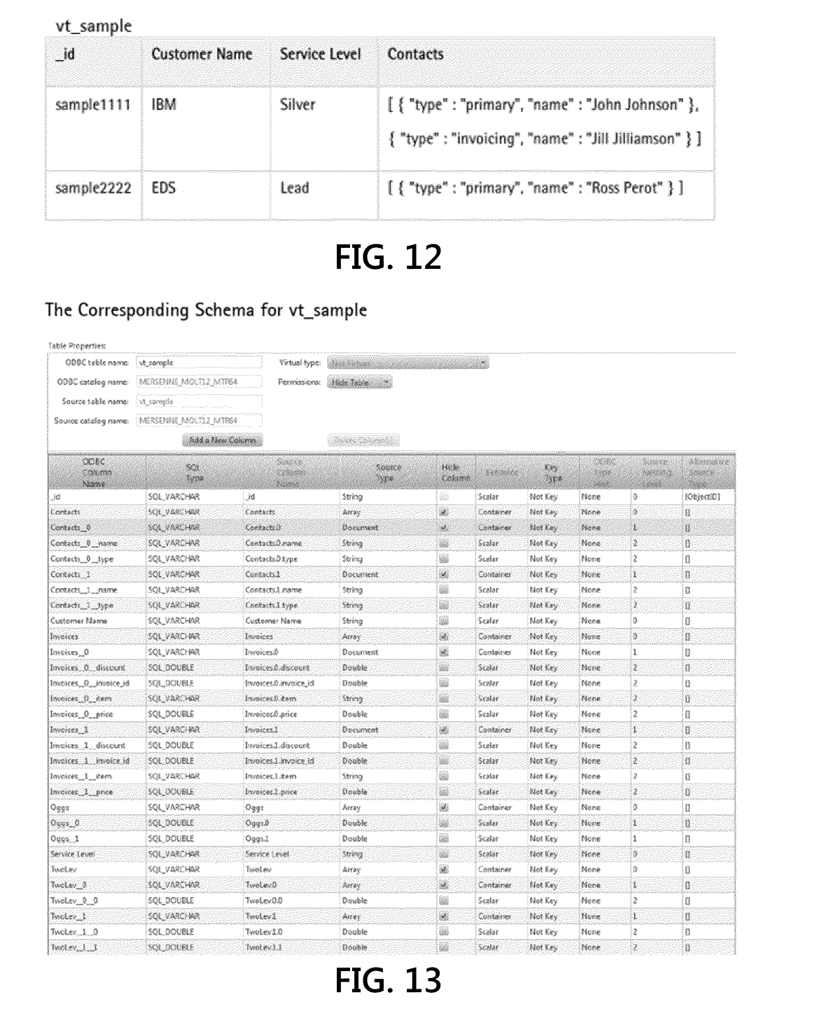

Additionally, schema definition tool 212 may enable schema operator 214 to add or delete columns to a table and also assign various properties to the added columns (e.g., relational column name, relational type, source column name, source type, etc.). FIG. 12 depicts an illustrative virtual table and FIG. 13 illustrates an example of a user interface for schema operator 214 to view and edit a schema definition of virtual table of FIG. 12.

In step 336, schema definition tool 212 may store the schema definition in a synthetic schema cache for future use and/or updating. In some instances, the schema operator may tune the schema based on his/her understanding of the data and/or system. If the operator knows that the few Datestamp values in a Boolean column are erroneous, the operator can override the schema definition tool's tool and declare the column as Boolean. Beyond adjusting the types of a column, the operator can also remove or add columns as necessary to provide a more complete illusion that the underlying non-relational database has schema.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A system comprising:
a non-relational database;
a first server communicatively coupled to the non-relational database; and
a computing device communicatively coupled to the first server, wherein the computing device comprises a processor and a computer readable medium storing instructions that, when executed by the processor, cause the computing device to:
transmit, from the computing device to the first server, instructions to sample and filter one or more tables residing in the non-relational database;
receive, from the first server, a sample set of the one or more tables that meets constraints provided in the instructions;
determine that a cell of a first table, of the one or more tables, includes an array;
determine a number of elements in the array;
generate a virtual table that duplicates the first table;
replace a column of the virtual table that includes the array with a column representing the number of elements in the array; and
generate a schema definition for the non-relational database that includes a table definition of the virtual table.

2. The system of claim 1, wherein the computer readable medium stores instructions that, when executed by the processor, further cause the computing device to:
format a first relational query using the schema definition;
transmit, from the computing device to the first server, the first relational query for the non-relational database; and
receive, from the first server, a first set of data results of the non-relational database for the first relational query.

3. The system of claim 2, further comprising:
a relational database; and
a second server communicatively coupled to the relational database, wherein the computing device is communicatively coupled to the second server,
wherein the computer readable medium stores instructions that, when executed by the processor, further cause the computing device to:
transmit, from the computing device to the second server, a second relational query for the relational database; and
receive, from the second server, a second set of data results of the relational database for the second relational query.

4. The system of claim 1, wherein the virtual table is a first virtual table, wherein the computer readable medium storing instructions that, when executed by the processor, further cause the computing device to:
generate a second virtual table to represent the array;
determine that the second virtual table includes a different array;
generate a third virtual table to represent the different array as scalar values; and
generate a table definition of the third virtual table to include in the schema definition.

5. The system of claim 4, wherein the computer readable medium stores instructions that, when executed by the processor, further cause the computing device to:
determine a number of elements in the different array; and
generate a row in the third virtual table for each element in the different array.

6. The system of claim 5, wherein the computer readable medium stores instructions that, when executed by the processor, further cause the computing device to:
determine a number of sub-elements in a first element of the different array; and
generate a column in the third virtual table for each sub-element.

7. The system of claim 6, wherein the computer readable medium stores instructions that, when executed by the processor, further cause the computing device to:
generate a column in the third virtual table for an index of the elements in the array.

8. The system of claim 7, wherein the computer readable medium stores instructions that, when executed by the processor, further cause the computing device to:
determine that a different column in the third virtual table comprises a plurality of different data types; and
assign a data type for the different column in the third virtual table suitable for representing the plurality of different data types, wherein the schema definition includes the assigned data type for the different column.

9. An apparatus comprising:
a processor; and
a computer readable medium storing instructions that, when executed by the processor, cause the apparatus to:
send, to a server communicatively coupled to a non-relational database, instructions for the server to sample the non-relational database;
receive, from the server, a sample dataset of the non-relational database;
determine that a cell of a table of the sample dataset includes an array;
generate a virtual table that represents the array;
determine that a column of the virtual table has a plurality of different data types;
assign a data type for the column to represent the plurality of different data types; and
generate a schema definition of the non-relational database that comprises the assigned data type for the column.

10. The apparatus of claim 9, wherein the computer readable medium stores instructions that, when executed by the processor, further cause the apparatus to:
generate a main virtual table to duplicate data in the table; and
replace a column in the main virtual table that includes the array with a column of a number of elements in the array.

11. The apparatus of claim 9, wherein the computer readable medium stores instructions that, when executed by the processor, further cause the apparatus to:
determining that the virtual table includes a different array; and
generate a different virtual table to represent the different array as scalar values.

12. The apparatus of claim 9, wherein the computer readable medium stores instructions that, when executed by the processor, further cause the apparatus to:
generate a row in the virtual table for each element in the array; and
generate a column in the virtual table for each sub-element of an element of the array.

13. The apparatus of claim 9, wherein the computer readable medium stores instructions that, when executed by the processor, further cause the apparatus to:
process a relational query on data within the non-relational database.

14. The apparatus of claim 13, wherein the relational query is a structure query language (SQL) query and the non-relational database is a not only SQL (NoSQL) database.

15. A method comprising:
sampling, by a processor of a computing device, a non-relational database to obtain a first table;
determining, by the processor, that a cell in the first table includes an array;
in response to the determining, generating, by the processor, a first virtual table and a second virtual table, wherein the first virtual table represents the first table and the second virtual table represents the array; and
generating, by the processor, a schema definition including a first table definition for the first virtual table and a second table definition for the second virtual table.

16. The method of claim 15, further comprising:
determining that the second virtual table includes a different array; and
in response, generating a third virtual table to represent the different array as scalar values.

17. The method of claim 15, wherein the first virtual table duplicates the first table, further comprising:
determining a number of elements in the array; and
replacing a column of the first virtual table that includes the array with a column of the number of elements in the array.

18. The method of claim 15, further comprising:
generating a row in the second virtual table for each element in the array;
generating a column in the second virtual table for an index of the elements in the array;
determining that an element of the array has a first sub-element and a second sub-element;
generating a column in the second virtual table for the first sub-element; and
generating a column in the second virtual table for the second sub-element.

19. The method of claim 18, further comprising:
determining a data type to represent each of the data types in the generated column in the second virtual table for the first sub-element; and
generating a table definition for the second virtual table that includes the determined data type, wherein the schema definition comprises the table definition.

20. The method of claim 19, further comprising:
using the schema definition to format a relational querie to be sent to the non-relational database, wherein the schema definition is generated in response to receiving the relational query.
